(19) United States
(12) Patent Application Publication
(10) Pub. No.: US 2002/0078813 A1
(43) Pub. Date: Jun. 27, 2002

(54) Saw blade

(76) Inventor: Steve E. Hoffman, Englewood Cliffs, NJ (US)

Correspondence Address: DRINKER BIDDLE & REATH, ONE LOGAN SQUARE, 18TH AND CHERRY STREETS, PHILADELPHIA, PA, 19103-6996, US

(21) Appl. No.: 09/965,162

(22) Filed: Sep. 27, 2001

Related U.S. Application Data
(60) Provisional application No. 60/236,001, filed on Sep. 28, 2000.

(51) Int. Cl. B27B 33/08

(52) U.S. Cl. 83/835; 76/112

(57) ABSTRACT

An improved saw blade is disclosed that includes a high precision finish on the blade for providing a low friction surface. Preferably the surface finish is less than approximately 10 Ra. The low friction surface allows for a thinner cutting tip relative to the blade. A method for forming a saw blade having a high precision surface finish. The method involves providing a high speed centrifugal finishing apparatus having an outer vessel and at least one inner vessel. A plurality of saw blades are mounted into the inner vessel, each saw blade being spaced apart from an adjacent saw blade. An abrasive finishing media is added into the inner vessel. The inner vessel is then rotated at high speed relative to the outer vessel. The high speed rotation causes the abrasive media to surface finish the blades. The finished saw blades are then removed from the inner vessel.

### RELATED APPLICATION

The present application is related to and claims priority from U.S. Provisional Application Serial No. 60/236,001, filed Sep. 28, 2000, which is incorporated herein by reference in its entirety.

### FIELD OF THE INVENTION

The present invention relates to saw blades and, more particularly, to a saw blade with an improved surface finish that facilitates cutting of a workpiece and extends the life of the saw blade.

### BACKGROUND

The are many factors which impact on the efficiency of a manufacturing cutting process, such as cutting tool life, operator fatigue, and inaccuracy in cutting. These factors limit how quickly and easily parts can be manufactured.

Cutting tool wear results from repeated contact between the cutting tool and the workpiece and directly correlates with the life of the product. The contact between the workpiece and the cutting tool also produces friction which, in turn, generates heat that can adversely affect the life of the tool. For example, as a saw blade cuts through a workpiece, the sides of the blade contact the sides of the groove that has been cut into the workpiece. The sides of conventional saw blades have a relatively rough finish. As such, when the abrasive surface of the saw blade contacts the abrasive surface of the cut groove, a large degree of friction results which quickly heats up the workpiece and the saw blade. Excessive heat can result in damage to the saw blade and/or the workpiece.

Operator fatigue also reduces production efficiency. Operator fatigue is generally magnified by the frictional resistance between the cutting tool and the workpiece. As discussed above, when the sides of a saw blade contact the workpiece, friction develops between the two rough surfaces. This frictional interaction is transmitted directly to the operator as cutting resistance requiring the operator to apply more force to cut the part.

In order to minimize contact between the blade and the workpiece, conventional saw blades are formed such that the width of the cut (commonly referred to as the saw set), which is defined by either the width of the cutting tip for straight saw blades or the overall width formed by the laterally offset teeth in non-straight saw blades, is slightly oversized from the blade or body of the saw blade. This oversize in the cut provides clearance between the blade and the cut portions of the workpiece. The amount of clearance will vary depending on the size and type of saw blade. While adding clearance between the saw blade and the cut portion of the workpiece helps reduce the contact between the saw blade and the workpiece, any lateral movement of the saw blade will still result in the tool contacting the workpiece.

Another problem with conventional saw blades actually results from the clearance that is introduced between the width of the teeth and the blade or plate to alleviate the frictional contact discussed above. The clearance between the teeth and the blade can produce wobble of the saw blade as it cuts through the workpiece. This can result in misdirection of the saw blade, producing an inaccurate cut. Most manufactures of saw blades, however, feel that this is an acceptable deficiency in conventional saw blades since reducing operator fatigue and extending tool life are paramount.

A need, therefore, exists for an improved saw blade and method of forming a saw blade which reduces tool wear, operator fatigue and inaccurate cutting.

### SUMMARY OF THE INVENTION

The present invention relates to an improved saw blade that includes a blade portion having two opposed sides which define a blade width, and blade teeth. The side surfaces of the blade portion and/or the blade teeth have a high precision surface finish which provide a low friction surface (i.e., surface with a low coefficient of friction). Preferably the surface finish is less than approximately 10 Ra. The blade also includes a plurality of cutting edges which are formed about the periphery of the blade portion.

In one embodiment, the saw blade is a straight saw blade and the width of the blade portion is substantially the same as the width of the cutting tip. In another embodiment, the saw blade includes an anti-kickback portion located radially behind each cutting tip, and wherein the side surfaces and/or the radially outer contact surface of the anti-kickback portion are finished with a low friction surface.

The present invention also relates to a method of forming a saw blade having a high precision surface finish. The method involves providing a high speed centrifugal finishing apparatus having an outer vessel and at least one inner vessel. A plurality of saw blades are mounted into the inner vessel, each saw blade being spaced apart from an adjacent saw blade. An abrasive finishing media is added into the inner vessel. The inner vessel is then rotated at high speed relative to the outer vessel. The high speed rotation causes the abrasive media to surface finish the blades. The finished saw blades are then removed from the inner vessel.

Preferably an abrasive finishing media is selected that is harder than the saw blade material, and softer than the cutting tip material.

The foregoing and other features and advantages of the present invention will become more apparent in light of the following detailed description of the preferred embodiments thereof, as illustrated in the accompanying figures. As will be realized, the invention is capable of modifications in various respects, all without departing from the invention. Accordingly, the drawings and the description are to be regarded as illustrative in nature, and not as restrictive

### BRIEF DESCRIPTION OF THE DRAWINGS

For the purpose of illustrating the invention, there is shown in the drawings a form which is presently preferred; it being understood, however, that this invention is not limited to the precise arrangements and instrumentalities shown.

FIG. 1A illustrates a partial cross-sectional view of a conventional saw blade with offset teeth.

FIG. 1B illustrates a partial cross-sectional view of a conventional saw blade with a cutting tip.

FIG. 1C is a schematic representation of an enlarged detail of the surface of the conventional saw blade of FIG. 1A.

FIG. 2A illustrates a partial cross-sectional view of a cutting blade with offset teeth made according to the present invention.

FIG. 2B illustrates a partial cross-sectional view of a cutting blade with a cutting tip made according to the present invention.

FIG. 2C is a schematic representation of an enlarged detail of the surface of the saw blade shown of FIG. 2A made in accordance with the present invention.

FIG. 3 is a is a perspective view showing one embodiment of a high speed centrifugal finishing apparatus for use in forming the surface finish on the saw blade according to the present invention.

FIG. 4 is a perspective view of a portion of the high speed centrifugal finishing apparatus of FIG. 3 showing the inner vessels mounted within the outer vessel.

FIG. 5 is a cross-sectional view of a portion of a high speed finishing apparatus.

FIG. 6 is a cross-sectional of one embodiment of an inner vessel with the saw blades mounted within it.

FIG. 7 is a plan view of a saw blade made in accordance with the present invention.

### DETAILED DESCRIPTION OF THE PREFERRED EMBODIMENTS

For the purpose of illustrating the invention, there is shown in the drawings one or more embodiments of the invention which are presently preferred; it being understood, however, that this invention is not limited to the precise arrangements and instrumentalities shown.

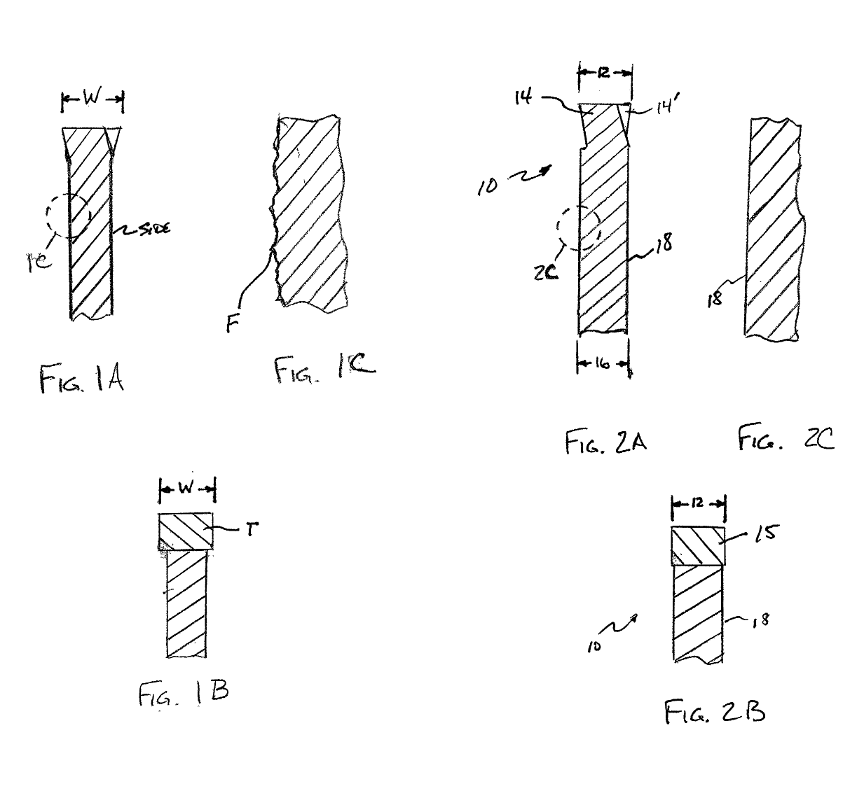

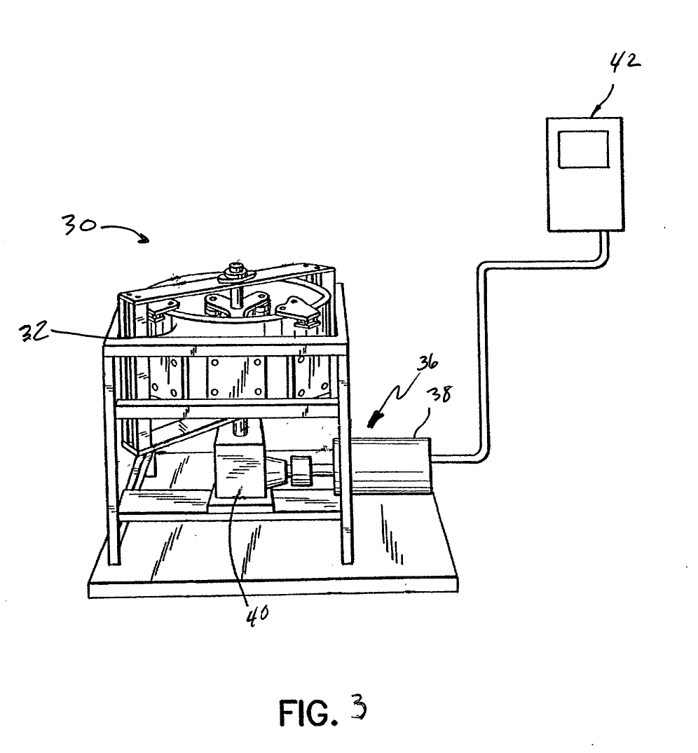

FIG. 1A illustrates a partial cross-sectional view of a conventional saw blade. As discussed above, a conventional saw blade includes a cutting tip width W which defines the spacing or clearance that will result between the cut formed in the workpiece and the blade. The cutting tip width W is defined by either the overall width of the offset teeth (called spring-setting and shown in FIG. 1A), or the actual width of the straight cutting tip T (called swage-setting and shown in FIG. 1B). A schematic representation of an enlarged detailed view of the side of the saw blade is shown in FIG. 1A, illustrating a conventional brushed steel finish F formed on the blade portion of the saw blade. A brushed steel finish is generally very rough.

Referring now to FIGS. 2 and 7, a saw blade 10 according to the present invention is shown. It should be recognized that the present invention is applicable for handsaws, hacksaws and circular saw blades, and the like. The saw blade 10 includes a cutting tip width 12 that is defined by either the overall width of the laterally offset teeth 14, 14′ on non-straight saw blades (shown in FIG. 2A), or the actual width of the cutting tips 15 on straight saw blades (shown in FIG. 2B). As will become more apparent below, the cutting tip width 12 in a saw blade made according to the present invention need not be larger than the width 16 of the blade 18.

FIG. 2C is an enlarged schematic representation of a blade 18 of the saw blade 10. The enlarged drawing illustrates the smooth surface that is formed on the blade 18 of the present invention. In particular the blade 18 side surfaces have a high precision polished or finished surface of less than 10 Ra. In one embodiment, the blade 18 has a finished surface of approximately 6 Ra or less. A more preferred surface finish is between approximately 2 Ra and 4 Ra. This finish results in the blade portion 18 of the saw blade 10 having a low coefficient of friction when in contact with the workpiece. As a result, the smooth surface acts as a lubricant which permits the blade 18 to slide virtually uninhibited along the cut surface of the workpiece. In contrast, a conventional saw blade has a surface finish of approximately 45 Ra to 50 Ra.

By providing this low frictional surface on the saw blade 10, the cutting tip width 12 on the saw blade 10 does not have to be significantly wider than the width 16 of the blade 18, i.e., the cutting tip width 12 can be substantially the same as the width 16 of the blade 18. Because of the low frictional surface finish, the sides of the blade 18 operate as guides which assist in channeling or directing the saw blade 10, and thus the cutting teeth 14 or tips 15, in a straight line. This results in a more precise cut. In contrast, the width of cutting tip on a conventional blade must be significantly larger than the width of the blade body so that the blade does not bind during use.

The smooth finish also addresses the problem of workpiece expansion. When wood or plastic is cut, there is a tendency for the material to expand (i.e., the cut sides to move toward one another.) This can result in the saw blade freezing in the workpiece. Prior art saw blades addressed this problem by forming the blade portion of the saw blade thinner than the teeth in an attempt to prevent the sides from contacting the workpiece. The smooth surface of the present invention, however, eliminates any concern for the expansion of the workpiece since the low friction surface acts like a lubricated surface, allowing the saw blade to freely cut through the workpiece.

Another benefit of the present invention is the ability to reduce the width of the cutting tip 15 in a straight blade. Many metal-cutting industrial blades are made with expensive tips, such as carbide tips. As noted above, since the blade 18 can now have a blade width 16 substantially the same as the cutting tip width 12, the cutting tips 15 can actually be formed smaller in width than on conventional saw blades. Reducing the width of the tip 15 results in a substantial savings over conventional blades (e.g., less carbide).

While the above embodiment describes the finishing of the entire side surface of the saw blade, it is also contemplated that the high preceision finished surface is provided only on the portion of the blade that is likely to contact the material being cut. For example, in one embodiment, only the sides of the teeth include the high precision finish.

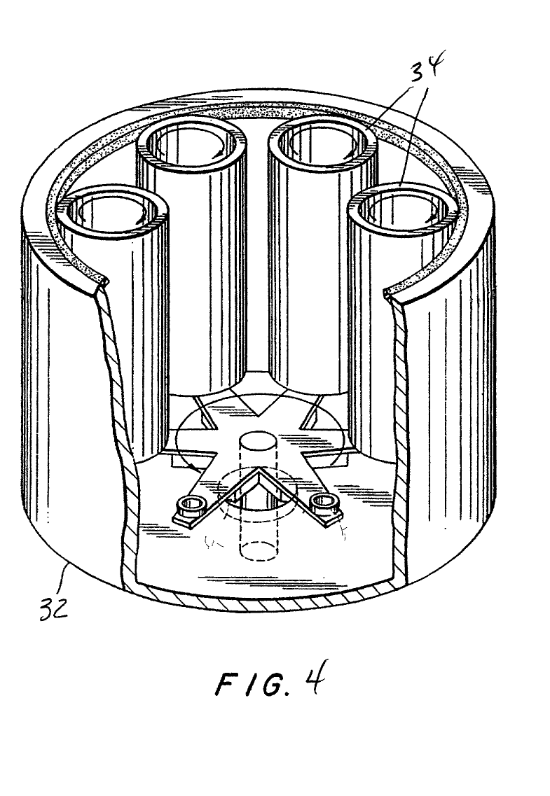

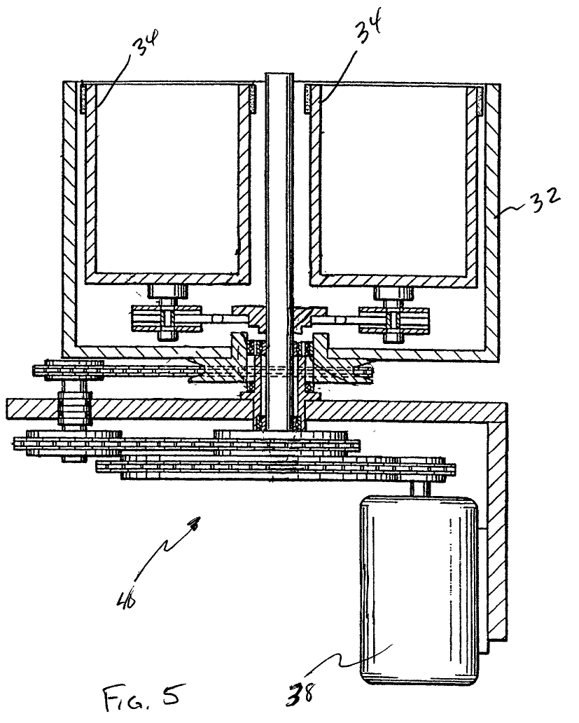

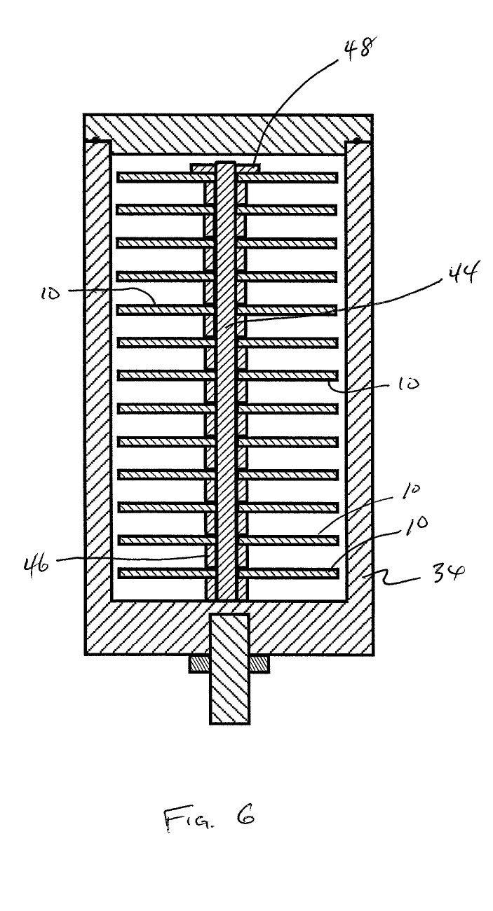

It has been determined that the surface finish on the saw blade 10 can be formed using the processes disclosed in U.S. Pat. Nos. 5,140,783, 5,507,685 and 5,848,929. These processes are used in combination with a new fixture which supports the saw blades 10 during the finishing process. FIG. 3 illustrates one embodiment of a device which can be used to finish the blades. The illustrated embodiment is for exemplary purposes only. Those skilled in the art would be readily capable of applying other devices for finishing the blades in light of the teachings provided herein and the disclosures in the above reference patents. The apparatus 30 includes an outer vessel 32 and one or more inner vessels 34 (shown in FIGS. 4 and 5). The inner vessels 34 are removably mounted within the outer vessel 32 Each inner vessel 34 is adapted to contain saw blades 10 that are to be subjected to a finishing process according to the present invention.

As shown in FIGS. 3 and 5, the inner vessel 34 is mounted to a drive system 36 which includes a motor 38 and a transmission or gearbox 40. In the illustrated variation of the drive system 36 shown in FIG. 5, the gearbox 40 includes a plurality of gears or pulleys. However, any conventional drive system can be used in the present invention.

The drive system 36 is adapted to rotate the inner vessels 34 around the inside periphery of the outer vessel 32 (which happens to be around the outer vessel's central axis when the outer vessel is cylindrical as shown in FIG. 3.) As discussed in more detail in U.S. Pat. No. 5,355,638, the mounting of each inner vessel 34 to the drive system 36 is such that the inner vessel 34 can rotate about its own central axis while concomitantly being driven around the inner surface of the outer vessel 32.

A controller 42, such as a signal processor, electronic or digital controller or other type of motor control, is used to control the speed and direction of rotation of the motor and/or control the engagement, shifting or disengagement of the gearbox. Controllers are well known to those skilled in the art and, therefore, no further discussion is needed.

The details of how the inner vessel 34 is drive with respect to the outer vessel 32 are provided in U.S. Pat. Nos. 5,140,783, 5,507,685 and 5,848,929, which patents are incorporated herein by reference in their entirety. Another drive system which can be used in the present invention is disclosed in co-pending application entitled “High Speed Centrifugal Processor” (attorney docket no. 9436-15 U.S.), filed concurrently herewith. That application is also incorporated herein by reference in its entirety.

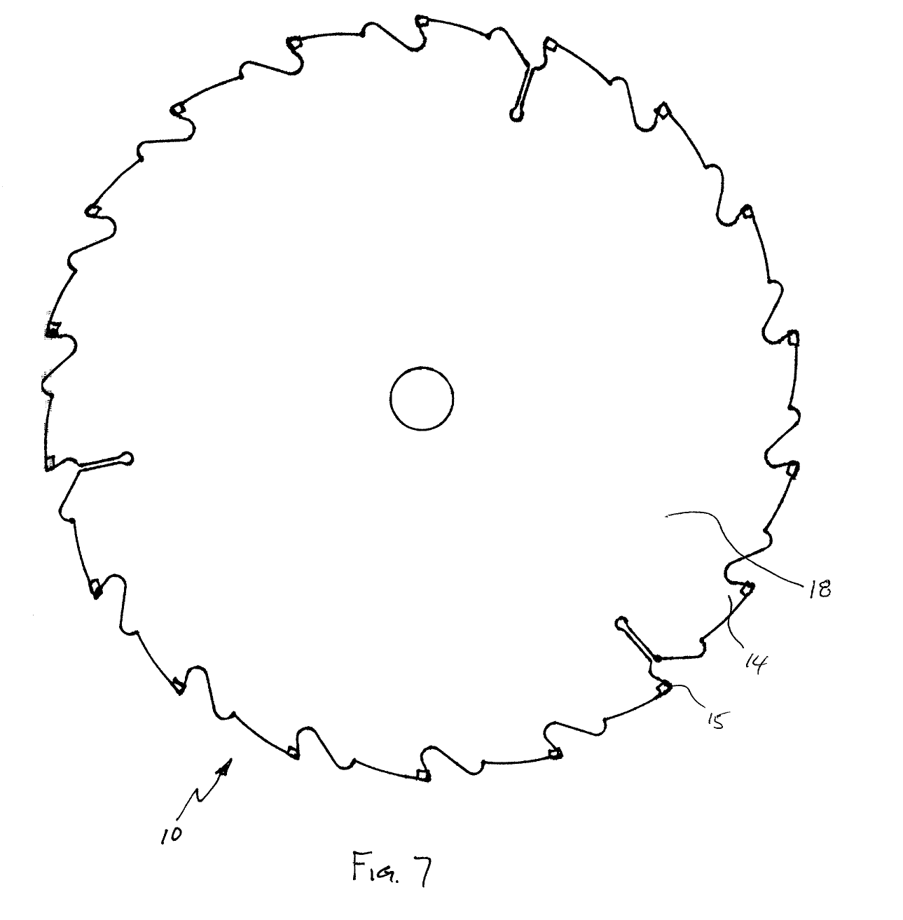

FIG. 6 shows one example of an arrangement for mounting the saw blades 10 in an inner vessel 34. A central rod 44 is located within the interior of the inner vessel. The saw blades 10 are mounted on the rod 44 and spaced apart by spacers 46. The height of the spacers 46 must be sufficient to permit the finishing media to pass between and act upon the sides of the blade. A nut or similar fastener 48 is attached to the end of the rod 44. The rod is preferably fixedly attached to the inner vessel 34. The walls of the inner vessel 34 should spaced from the tips of the blades to prevent any damage to the tips. In another embodiment, instead of a rod that extends through the saw blade center holes, a series of supports can be provided inside the inner vessel which each have magnets on them. The saw blades would be held to the supports by the magnets.

In order to prevent damage to the saw blade tip 15, the present invention contemplates the selection of abrasives that have a hardness that is harder than the blade 18, but softer than the tip 15. This results in selective working of only the blade portion 18 of the saw blade 10.

The process described above yields additional benefits which help extend the life of the saw blade. For example, the process results in the saw blade surface being resistant to rust. This occurs because the high speed finishing process produces and occlusion free surface which prevents rust from generating. As such, the need to rust proof coat or paint the saw blade for protective purposes is reduced or completely eliminated using the present invention.

The saw blade 10 according to the present invention also produces a more accurate and smooth cut since the blade 18 helps guide the saw blade and cutting tips. The smooth surface of the blade 18 acts like a lubricated surface, reducing the friction developed between the saw blade 10 and the workpiece. This results in reduced energy requirements, while at the same time providing for more efficient cutting action. The smooth surface also reduces the noise that is generated with conventional saw blades when they contact the workpiece.

As discussed above, the present invention permits the tip or teeth to have essentially the same width as the blade 18. While reducing the tip 15 width is one way to achieve this, it is also contemplated that the blade 18 can be widened to be essentially the same thickness as the tip 15 or teeth 14. The wider blade 18, would be more structurally stable than its conventional counterparts. The added structural stability also permits the saw blade 10 to be formed without the need for heat treating. Accordingly, the resulting saw blade is less expensive to manufacture. Also, thicker saw blades are more resistant to vibrations, which can lead to operator fatigue.

It has also been determined through testing that the precision polishing of the saw blade reduces and/or eliminates embrittlement in the blade. During a normal heat treating process, microscopic fractures form within the steel blade. These eventually become the source of blade failure by cracking. The high speed precision polishing process used in the present invention produces a universal stressing of the surface of the metal, similar to shot peening a part. This results in a structurally different blade. Conventional shot peening could not be used on such blades because of the resulting damage that would occur to the teeth and the uneven change in surface characteristics (i.e., nonplanar) that would result. The precision finishing process of the present invention provides enhanced material characteristics previously unseen in saw blades.

A saw blade made in accordance with the present invention was tested against an untreated conventional blade by an independent organization. A .22 gauge bullet was shot at both from the same range . The bullet passed through untreated conventional blade. The bullet did not completely pass through the saw blade treated as described above. The results showed that the finishing process reduced the embrittlement in the blade, thereby producing a structurally different blade, less susceptible to cracking.

Another feature of the present invention is the polishing that is provided on the anti-kickback 50 portion of the blade. An anti-kickback 50 is located circumferentially aft or behind each tooth 14. Anti-kickback portions are well known in the art. These portions are generally metal protrusions that are radially shorter than the tooth and are designed to guide the blade cut and limit the next cutting tip from digging too deep into the material. Because the anti-kickback is in contact with the material, it is subject to friction. In prior designs, the frictional contact between the anti-kickback and the not considered important and, thus, was completely overlooked. As such, excessive friction typically occurs in these types of blades. In the present design, the high precision polishing of the anti-kickback further reduces friction and permits the anti-kickback to function more as a guide for the subsequent tooth. This results in a very straight cut. The high precision finish are formed on the side surfaces of the anti-kickback portion. Alternately or in addition to the finishing of the side surfaces, the radially outboard edge of the anti-kickback portion may also be surface finished as described above since this portion of the blade rides on the material. The desired values for surface finishing described above apply equally as well to the anti-kickback portion.

As discussed above, it is contemplated that the blade in the present invention can be made with only the high precision surface finish made on the kickback portion and in the vicinity of the cutting tips as opposed to the entire blade.

While the above discussion has been directed to a saw blade embodiment, it is also contemplated that the present invention can be used with other saw-type cutting tools, such as hacksaws, handsaws, bandsaws and the like.

The above benefits are clearly unexpected and contrary to conventional saw blade design and manufacturing practices.

Although the invention has been described and illustrated with respect to the exemplary embodiments thereof, it should be understood by those skilled in the art that the foregoing and various other changes, omissions and additions may be made therein and thereto, without parting from the spirit and scope of the present invention.

What is claimed is:

1. An improved saw blade comprising:
a blade portion having two opposed sides which define a blade width, the blade portion having a high precision surface finish which is less than approximately 10 Ra; and
a cutting edge formed on the blade portion, the cutting edge having a cutting tip width.

2. An improved saw blade according to claim 1 wherein the saw blade is a straight saw blade and wherein the width of the blade portion is substantially the same as the width of the cutting tip.

3. An improved saw blade according to claim 1 wherein the saw blade includes an anti-kickback portion located circumferentially behind each cutting tip, and wherein the side surfaces of the anti-kickback portion are finished with a low friction surface.

4. An improved saw blade according to claim 1 wherein the high precision surface finish is in a range of between approximately 2 Ra and 6 Ra.

5. An improved saw blade according to claim 1 wherein the high precision surface finish is in a range of between approximately 2 Ra and 4 Ra.

6. An improved saw blade according to claim 1 wherein the high precision surface finish is approximately 6 Ra or less.

7. A method of forming a saw blade having a high precision surface finish; the process comprising the steps of
providing a high speed centrifugal finishing apparatus having an outer vessel and at least one inner vessel;
mounting a plurality of saw blades into the inner vessel, each saw blade being spaced apart from an adjacent saw blade;
adding abrasive finishing media into the inner vessel;
rotating the inner vessel at high speed relative to the outer vessel; the high speed rotation causing the abrasive media to surface finish the blades; and
removing the blades from the inner vessel.

8. A method of forming a saw blade according to claim 7 wherein before the step of adding the abrasive, the method comprises the step of selecting an abrasive finishing media which is harder than the saw blade material.

9. A method of forming a saw blade according to claim 8 wherein the abrasive finishing media is softer than the cutting tip material.

10. A method of forming a saw blade according to claim 7 wherein the step of mounting the saw blades involves providing a central rod, placing the saw blades on the central rod; and inserting spacers between adjacent saw blades.

11. A method of forming a saw blade according to claim 10 wherein before the step of adding the abrasive, the method comprises the step of selecting an abrasive finishing media which is harder than the saw blade material.

12. A method of forming a saw blade according to claim 11 wherein the abrasive finishing media is softer than the cutting tip material.

13. An improved saw blade comprising:
a blade portion having two opposed sides which define the blade portion width; and
a plurality of teeth formed on the blade portion, the teeth having opposed sides, the teeth having cutting tips formed thereon which have a width, the sides of the teeth having a high precision surface finish which is less than approximately 10 Ra.

14. An improved saw blade according to claim 13 wherein the saw blade is a straight saw blade and wherein the width of the blade portion is substantially the same as the width of the cutting tips.

15. An improved saw blade according to claim 13 wherein the saw blade includes an anti-kickback portion located circumferentially behind each cutting tip, and wherein at least a portion of the anti-kickback portion have a high precision low friction surface finish.

16. An improved saw blade according to claim 13 wherein the high precision surface finish is in a range of between approximately 2 Ra and 6 Ra.

17. An improved saw blade according to claim 13 wherein the high precision surface finish is in a range of between approximately 2 Ra and 4 Ra.

18. An improved saw blade according to claim 13 wherein the high precision surface finish is approximately 6 Ra or less.
